(19) United States
(12) Patent Application Publication
(10) Pub. No.: US 2015/0178655 A1
(43) Pub. Date: Jun. 25, 2015

(54) SYSTEM FOR USER GUIDANCE FOR CONNECTING BUSINESS FUNCTIONS

(71) Applicants: Ke Guo ZHOU, Shanghai (CN); Li CHENG, Shanghai (CN); Da CHENG, Shanghai (CN); Yu Jun PENG, Shanghai (CN)

(72) Inventors: Ke Guo ZHOU, Shanghai (CN); Li CHENG, Shanghai (CN); Da CHENG, Shanghai (CN); Yu Jun PENG, Shanghai (CN)

(21) Appl. No.: 14/135,547

(22) Filed: Dec. 19, 2013

(51) Int. Cl. G06Q 10/06

(52) U.S. Cl. CPC G06Q 10/06316

(57) ABSTRACT

Disclosed herein is a framework to organize functions to scenarios in order to guide users to complete processes. In accordance with one aspect, the framework determines an initial scenario. Particular functions may be assigned to the initial scenario. The initial scenario may be performed and other scenarios that follow the initial scenario may be presented.

### TECHNICAL FIELD

The present disclosure relates generally to providing user guidance to complete predefined business processes.

### BACKGROUND

In an enterprise or business system, independent business scenarios may be based on a number of functions and/or steps. For example, for a particular business system, a batch payment may include collecting invoices from various vendors, depositing into various banks, and configuring payment. A business system may include modifying the system with an “add-on” which may require several steps such as selecting the “binary” or add-on file, identifying the target system, uploading the file, and configuring necessary parameters. Such steps may have a very high or strict coherence or relationship with one another and can restrict flexibility or complicate implementation by the user.

Complications and issues can arise for users, especially new and beginner users that are not familiar with the system. Such problems include not knowing which scenarios may follow, after completing a particular scenario or scenarios. A very complex system may involve multiple scenarios and variations. In certain cases, scenarios may not have applicable context to one another, as applied to the need of a particular user.

A complex system involving workflow analysis may involve a number of users and scenarios. Proper connection and collaboration of users and scenarios may involve a relatively long time, such as over several days. A statistical workflow may be implemented; however, this still may prove complicated for users. Inter-relationships between functions and steps in the workflow may be confusing, especially when a large number of possible functions and steps are presented to a user. Although the enterprise system may provide full flexibility, a workflow typically focuses only on a small subset of the available functions.

### SUMMARY

Disclosed herein is a framework to organize functions to scenarios in order to guide users to complete processes. In accordance with one aspect, the framework determines an initial scenario. Particular functions may be assigned to the initial scenario. The initial scenario may be performed and other scenarios that follow the initial scenario may be presented.

In accordance with another aspect, an initial scenario with one or more functions may be presented. The initial scenario may be performed. Possible scenarios that follow the initial scenario may be determined. Other scenarios may be presented, and the framework may further determine whether to perform the other scenarios.

In accordance with yet another aspect, the framework may include one or more functions, and one or more scenarios that include processes that use the one or more functions. The framework may further include guides that are associated with the one or more scenarios that present the scenarios. In addition, user interfaces that are used by the guides may be provided to present the scenarios and scenarios that follow based on predetermined or historically determined user usage.

This summary is provided to introduce a selection of concepts in a simplified form that are further described below in the following detailed description. It is not intended to identify features or essential features of the claimed subject matter, nor is it intended that it be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates an exemplary system used in accordance with the technology described herein;

FIG. 2 illustrates another exemplary system used in accordance with the technology described herein;

FIG. 3 illustrates an exemplary scenario sequence and associated tables;

FIG. 4 illustrates an exemplary user interface used in accordance with the technology described herein;

FIG. 5 illustrates another exemplary user interface used in accordance with the technology described herein;

FIG. 6 illustrates another exemplary user interface used in accordance with the technology described herein;

FIG. 7 illustrates another exemplary user interface used in accordance with the technology described herein;

FIG. 8 illustrates another exemplary user interface used in accordance with the technology described herein;

FIG. 9 illustrates another exemplary user interface used in accordance with the technology described herein;

FIG. 10 illustrates another exemplary user interface used in accordance with the technology described herein;

FIG. 11 illustrates other exemplary user interfaces used in accordance with the technology described herein;

FIG. 12 illustrates other exemplary user interfaces used in accordance with the technology described herein;

FIG. 13 illustrates an exemplary table used in accordance with the technology described herein;

FIG. 14 illustrates another exemplary table used in accordance with the technology described herein;

FIG. 15 illustrates another exemplary user interface used in accordance with the technology described herein;

FIG. 16 illustrates an exemplary process used in accordance with the technology described herein; and

FIG. 17 illustrates an exemplary computing system to implement in accordance with the technologies described herein.

The Detailed Description references the accompanying figures. In the figures, the left-most digit(s) of a reference number identifies the figure in which the reference number first appears. The same numbers are used throughout the drawings to reference like features and components.

### DETAILED DESCRIPTION

Disclosed herein are technologies for organizing system functions, such as functions in an enterprise or business system, in way to guide users to complete predefined processes, while maintaining system flexibility. Examples of users include individuals, business or corporate entities, etc. Technologies herein may be applied to computing and mobile applications.

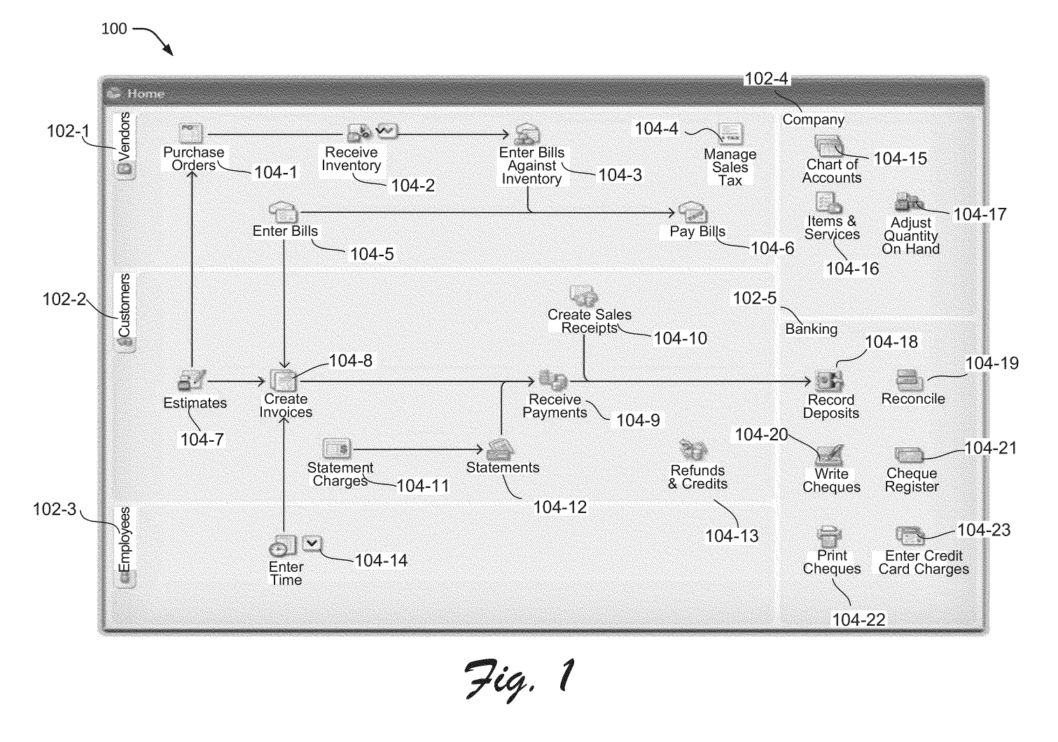

FIG. 1 shows an example system 100 that may be used to provide functions or processes to users as part of various scenarios. The various scenarios are defined by users 102. In particular, the technologies described herein guide the users in defining interrelationships of functions and steps. In this example, system 100 is a business system. The users are vendors 102-1, customers 102-2, employees 102-3, company(ies) 102-4, and banking 102-5. Various functions 104 are shown. Functions or steps 104 are defined for the various scenarios which the users 102 define.

In the business system 100, every independent scenario may be based on many functions and steps 104. For example, a batch payment includes collecting from vendors, creating invoices, contacting the bank, filtering, and configuring payment (i.e., various functions and steps 104).

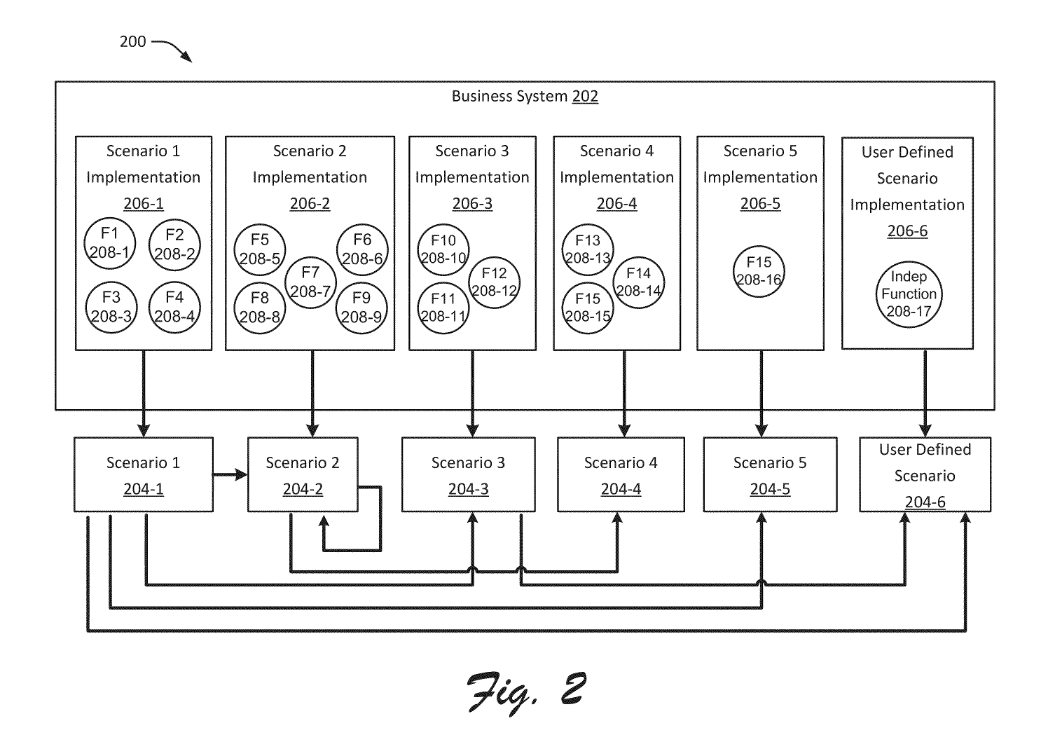

FIG. 2 shows an example system 200 that may be used to provide guidance to users in creating various scenarios. In this example, a business system 202 is described. Users define various scenarios 204-1 to 204-6, which are implemented by system 202 as scenario implementations 206-1 to 206-6. Scenario implementations 206-1 to 206-6 correspond directly to user scenarios 204-1 to 204-6. Scenario implementations include functions 208. It is to be understood that in certain cases, functions 208 may be the same function, although labeled differently in this example.

The scenarios 204 may be interrelated to other scenarios as illustrated by the arrows, or be looped back to itself (e.g., scenario 204-2). For example, scenario 1 204-1 is tied to scenario 3 204-3, scenario 5 204-5, and user defined scenario 204-6. The interrelationship of the scenarios may be predefined and/or weighted and presented to users, providing options to users to select particular scenarios, and configure a system. In certain implementations, a user may define a scenario, such as user defined scenario 204-6 which corresponds to a user defined scenario implementation 206-6. In this example, the user defined scenario implementation 206-6 includes an independent function 208-17.

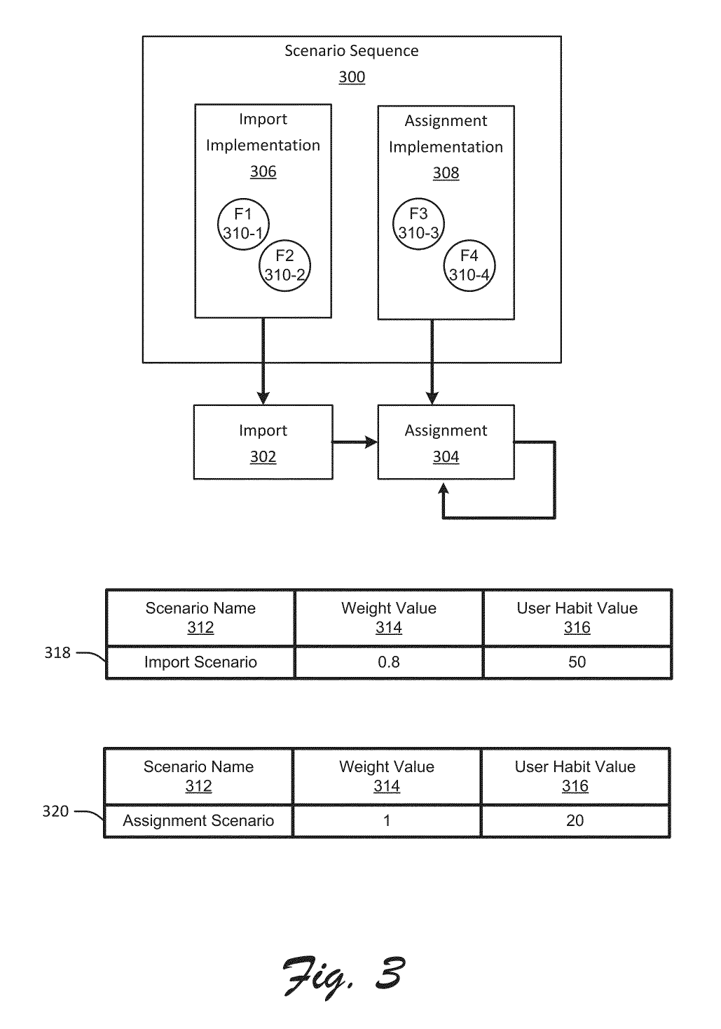

FIG. 3 shows an example of importing and assignment. In this example, an add-on (component) is imported into a system by a user. After the import scenario, the user is presented with an assignment scenario. In particular, a scenario sequence 300 includes an import scenario 302 and assignment scenario 304. Import scenario 302 is associated with an import implementation 306. Assignment scenario 304 is associated with an assignment implementation 308. The import implementation 306 and assignment implementation 308 respectively include functions 310. As discussed, functions or steps may be the same although labeled differently.

A user may be presented with a guide or “wizard” implementing a user interface or UI which is displayed on a computing device. The wizard walks the user through the processes, allowing the user to select from various scenarios. The scenarios may be presented in different and various user interfaces.

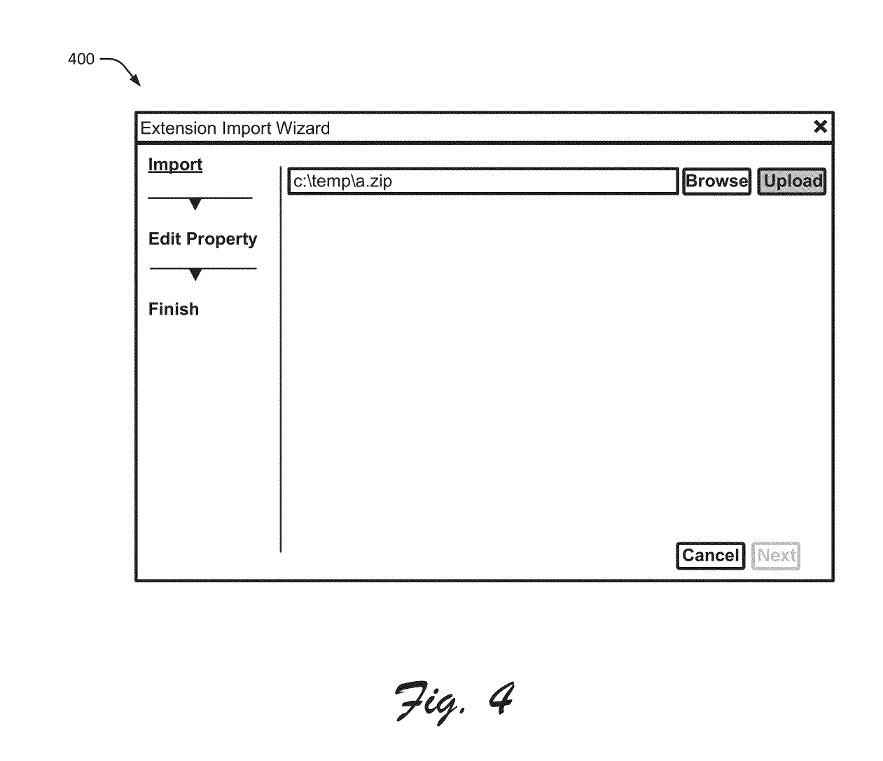

FIG. 4 shows an example user interface 400 for the import scenario. The user interface 400 provides for the user to import and to edit a property. In addition, a complete or finish option is given to the user.

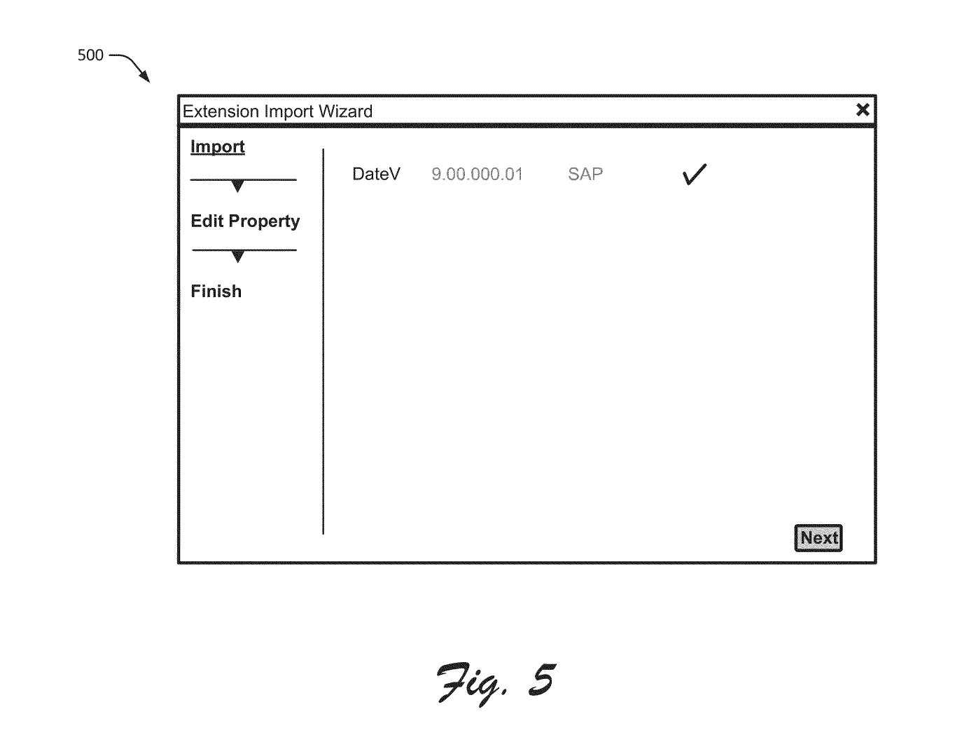

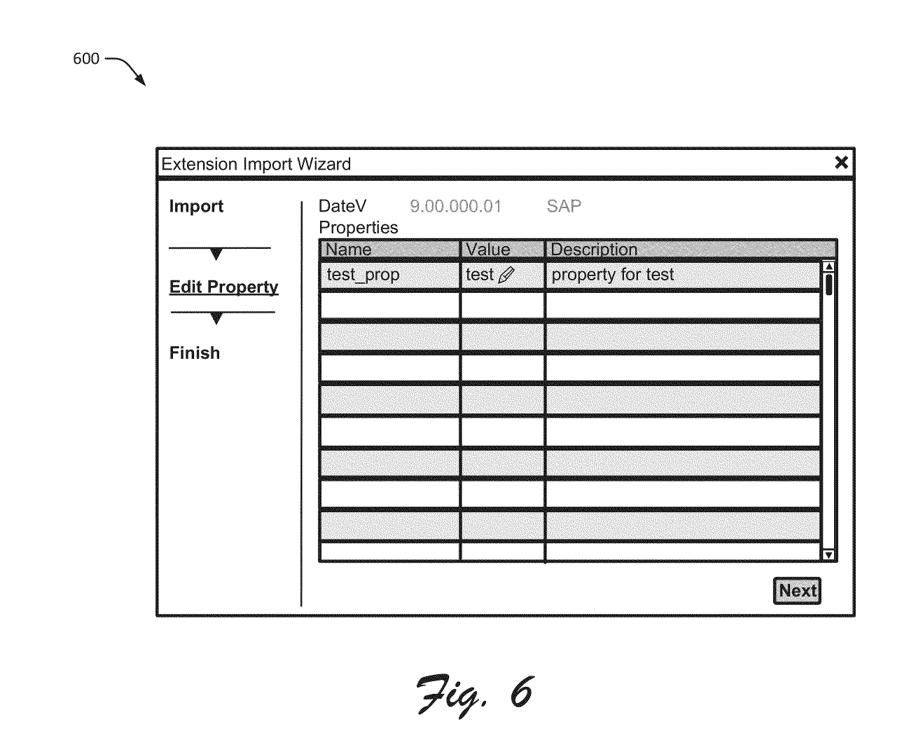

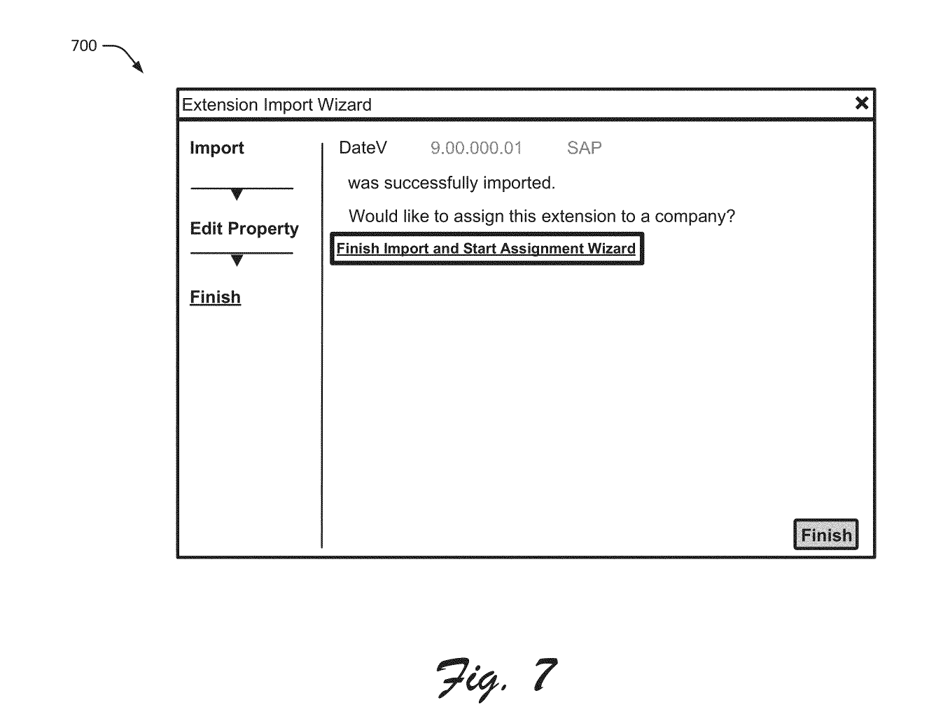

FIG. 5 shows an example user interface 500 to import a property. FIG. 6 shows an example user interface 600 that displays properties for editing. FIG. 7 shows an example user interface 700 that displays a finish option to the user.

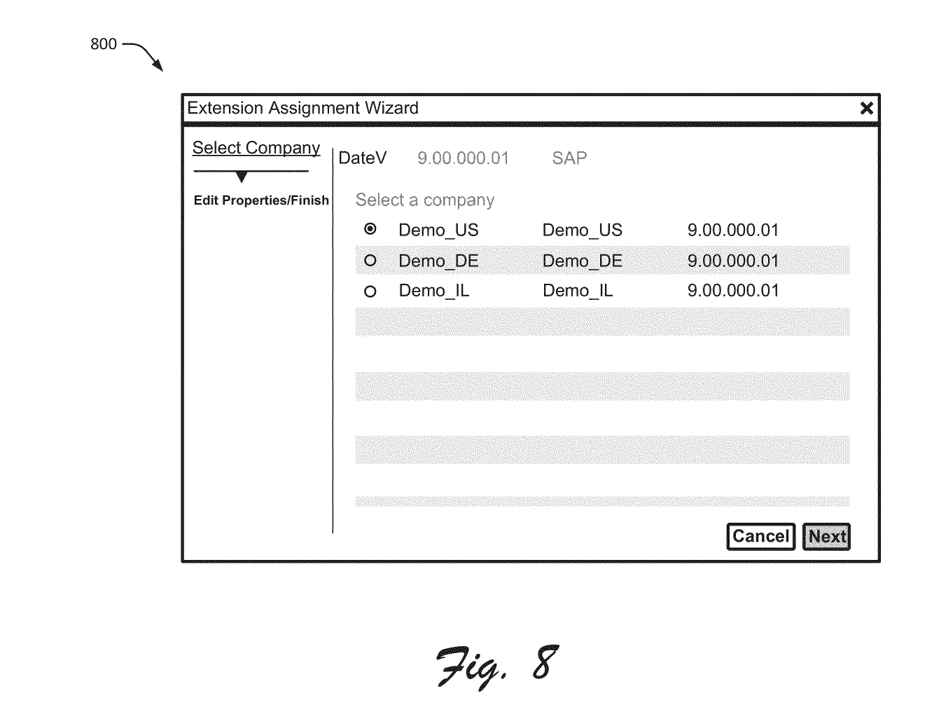

As discussed above, and in reference to FIG. 3, a user may be given the option to continue with an assignment scenario, based on a predetermined or historical heuristic. FIG. 8 shows an example user interface 800 for assignment scenario. The user interface 800 may be part of another wizard or guide, which allows the user to assign to other entities/companies.

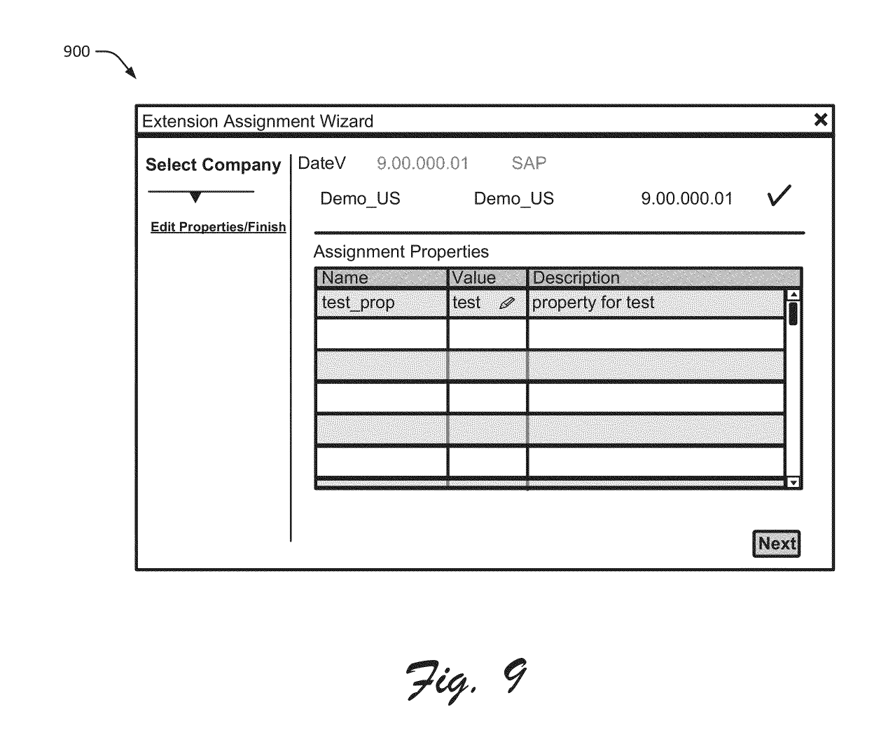

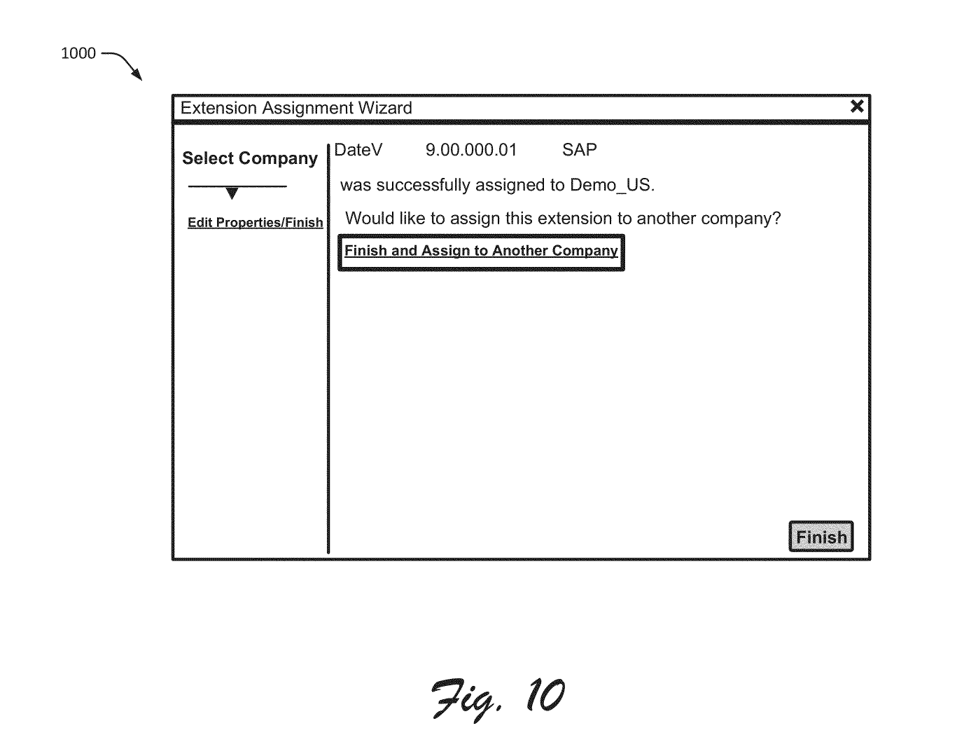

FIG. 9 shows an example user interface 900 to edit properties of the assignment function. FIG. 10 shows an example user interface 1000 that displays a finish option to the user.

A weak coupling relation is created for independent scenarios that are simple for a user to understand and follow. The system keeps flexibility in that all functions are available in an application. Large or main (important) business or system scenarios may be provided for in several connected guides or wizards. The guides or wizards may be connected with one another.

For example, a user may start with a particular guide or wizard A. At the end of the wizard A, another wizard B or wizard C can be started. A consistence navigation between wizards may be provided through various user interfaces.

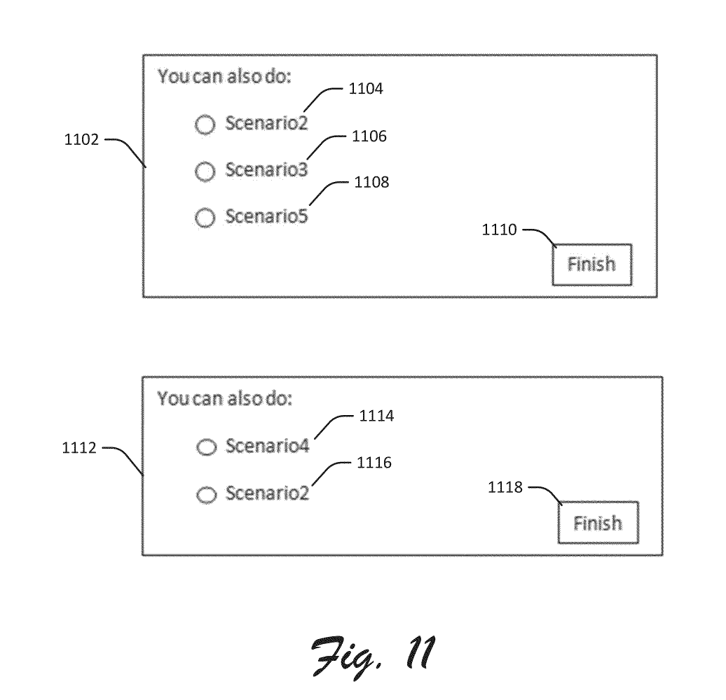

Referring back to FIG. 2, if scenario 1 204-1 is initiated, the user is provided the option to call up or initiate scenario 2 204-2, scenario 3 204-3, or scenario 5 204-5. Now in reference to FIG. 11, a user interface 1102 is shown that provides options for the user to continue with scenario 2 1104, scenario 3 1106, scenario 5 1008, or finish 1110.

If the user selects the option to proceed with scenario 2 1104, the process of scenario 2 as shown in FIG. 2 is followed. User interface 1112 in FIG. 11 shows the options provided after completing scenario 2, which are scenario 4 1114, scenario 2 1116 and finish 1118.

The following may be realized through implementation of the described inter relationships. Low decoupled scenarios are connected. The system is organized by functions, keeping flexibility. Connected scenarios have context. Therefore, users will not need to restore the context. Navigation is organized in discrete way to assist the user.

Organization of steps or functions in the diagram illustrated in FIG. 1 assures that a “main area” is occupied and available. The pattern provided in such a diagram may be applied to mobile applications. The pattern may be further refined or extended to allow for a single operation to be upgraded into a reduced or “mini” guide or wizard, even if there are only two steps in the wizard. For example, the first step may be the operation user interface itself and the second step may be a user interface connecting to later/proceeding scenarios. A user may define the user level scenarios based on independent functions and join the relation with other scenarios. Ordering of suggested scenarios may be improved with individual users through historical use data or user input.

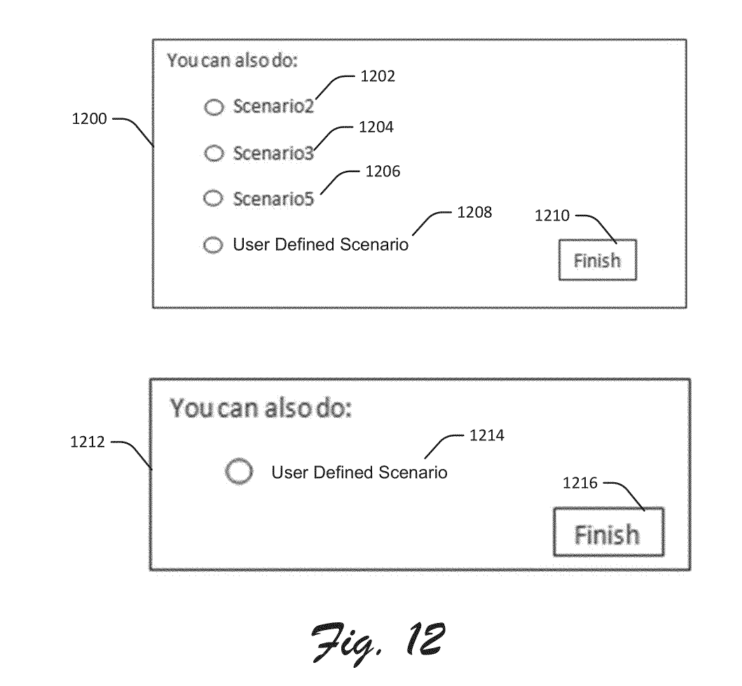

FIG. 12 shows example user interfaces that may be implemented in user defined scenario cases. A user may create a user defined scenario, such as user defined scenario 204-6 shown in FIG. 2. The user defined scenario may be based on one function. In the example of FIG. 2, a week coupling relation to scenario 1 204-1 and scenario 3 204-3 is created. Therefore, when scenario 1 204-1 is completed, a user interface such as user interface 1200 in FIG. 12 may be displayed. User interface 1200 includes the option of scenario 2 1202, scenario 3 1204, scenario 5 1206, user defined scenario 1208, and finish 1210.

Continuing with the example, if the user chooses and completes scenario 3, the user interface 1212 may be presented that allows the user to choose user defined scenario 1214 or finish 1216.

In certain implementations, scenario options are ordered by relation of scenario priority. Scenario priority may be determined using different algorithms, which may include weight value and user habit value. For example, the following may be used.

scenario priority value=weight value+(user habit value)/10 (1)

For example, the term “weight value” may depend on a particular business case. The values may range from 0 to 1. The more important other scenarios are to the current scenario, the larger the weight value. The term “user habit value” may be a value that the system records as to the user's choice. For example, every time the user chooses a particular scenario, the user habit value will add “1.”

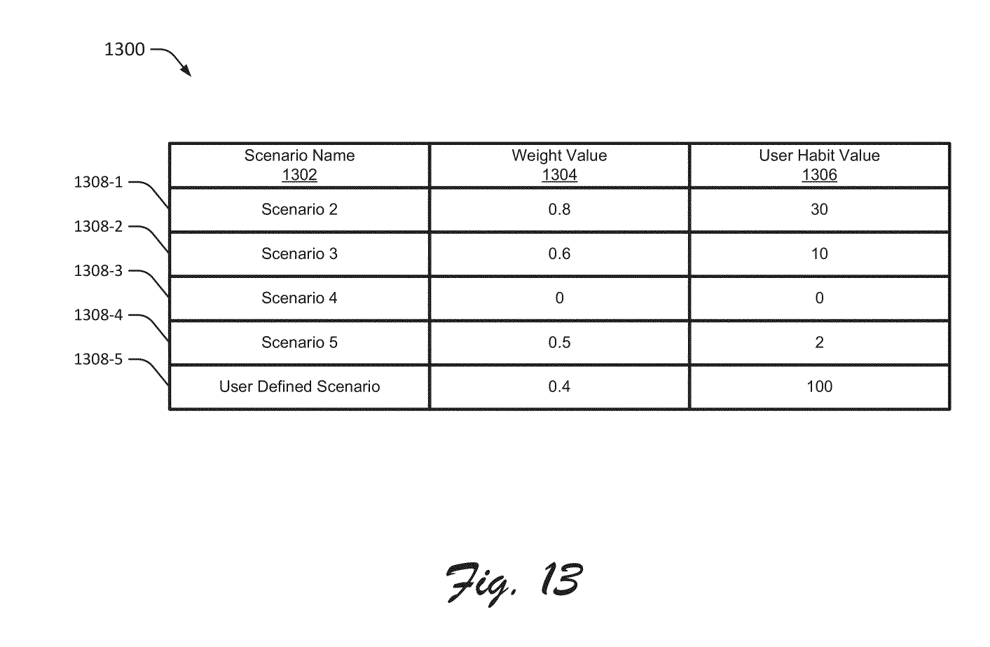

FIG. 13 shows an example table 1300. Table 1300 includes scenario name 1302, weight value 1304, and user habit value 1306 columns, and entries 1308.

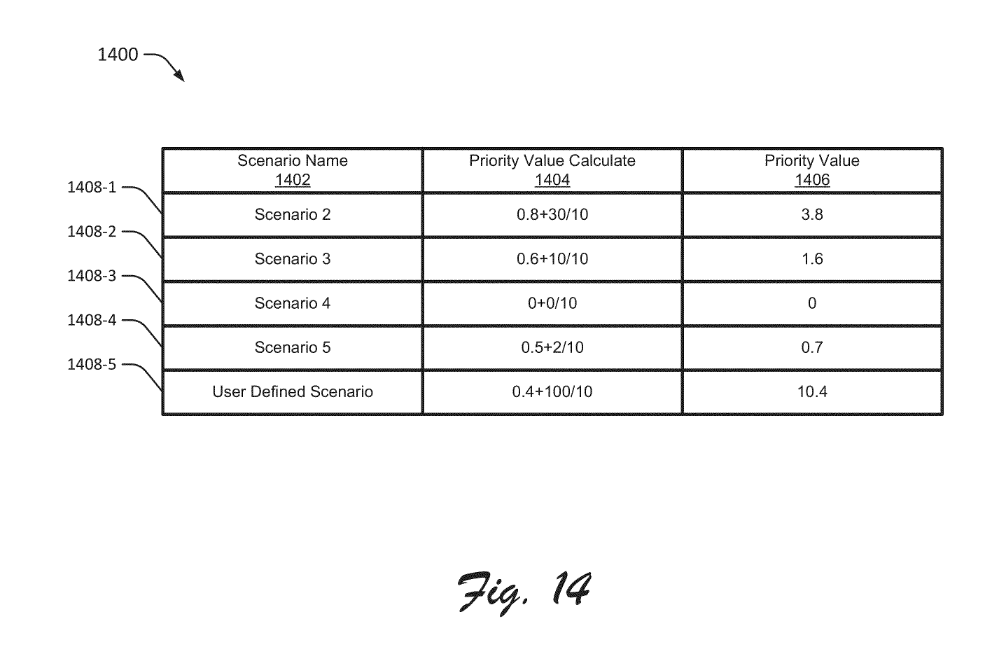

FIG. 14 shows an example table 1400. Priority values may be calculated for each scenario. Table 1400 includes scenario name 1402, priority value calculate 1404, and priority value 1406. The entries for priority value calculate 1404 add “weight value” to “user habit value” which is divided by 10, where 10 is a normalization value. Priority value 1406 is the result of priority value calculate 1406.

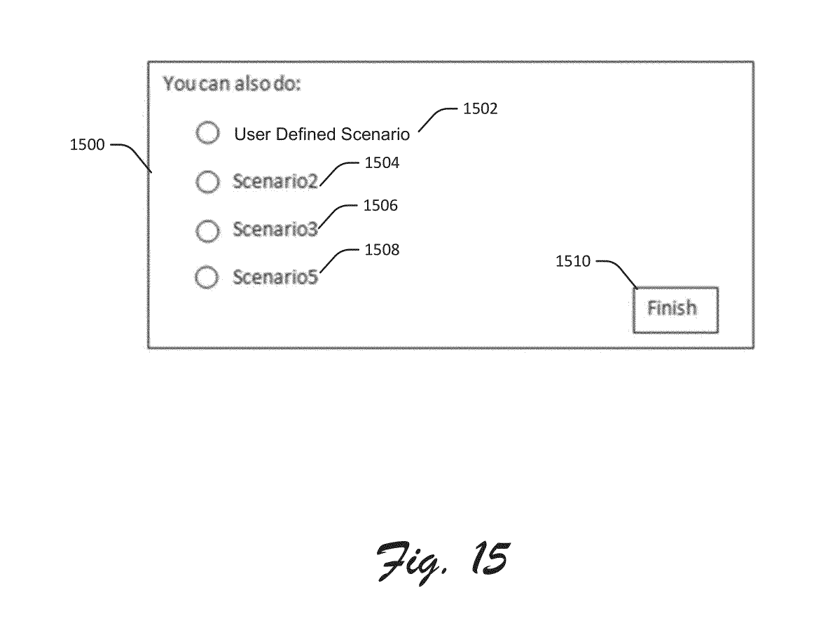

FIG. 15 is an example user interface. User interface 1500 lists the scenarios in order of priority value as applied to table 1400 described above. In this example, user defined scenario 1502, scenario 2 1504, scenario 3 1506, and scenario 5 1508 are listed in order of priority. A finish option 1510 is also provided by user interface 1500.

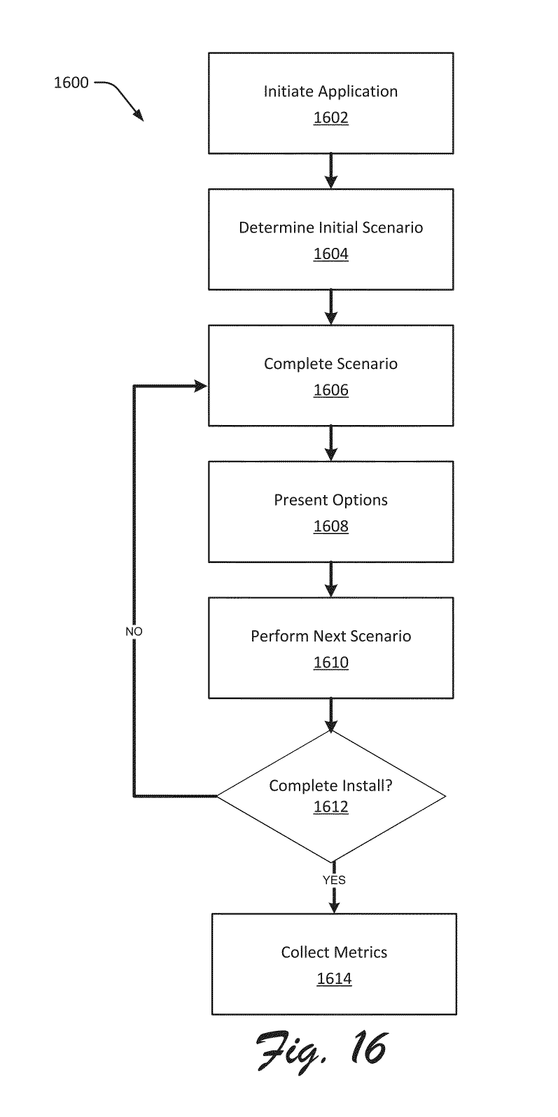

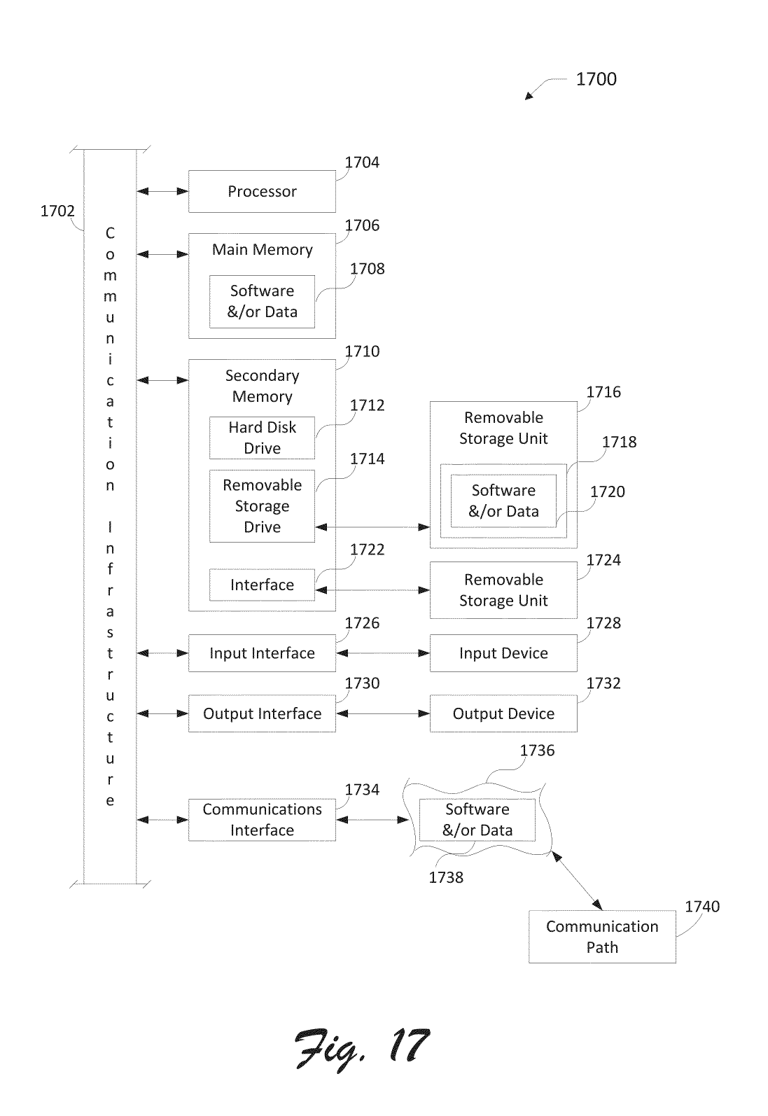

FIG. 16 illustrates an exemplary process 1600 for implementing, at least in part, the technology described herein. In particular, process 1600 depicts a flow to organize functions to scenarios in order to guide users to complete processes. The process 1600 may be performed by a computing device or devices. An example architecture of such a computer device is described below with reference to FIG. 17. In this particular example, the process 1600 describes that certain acts are to be performed at or by a user or a system.

At 1602, initiating of an application is performed. The application may be a business application that involves adding components or modification, as described above.

At 1604, an initial scenario is determined. The scenario may include various functions as described above.

At 1606, the scenario is performed or completed.

At 1608, different options that follow the present scenario may be presented.

At 1610, a subsequent scenario is performed.

At 1612, a determination is performed to determine if the installation is complete.

If the installation is complete, following the “YES” branch of 1612, at 1614, metrics may be collected to determine scenarios that are followed by the user. If the installation is not complete, then following the “NO” branch of 1612, 1606 is performed.

FIG. 17 illustrates an exemplary system 1700 that may implement, at least in part, the technologies described herein. The computer system 1700 includes one or more processors, such as processor 1704. Processor 1704 can be a special-purpose processor or a general-purpose processor. Processor 1704 is connected to a communication infrastructure 1702 (for example, a bus or a network). Depending upon the context, the computer system 1700 may also be called a client device.

Computer system 1700 also includes a main memory 1706, preferably Random Access Memory (RAM), containing possibly inter alia computer software and/or data 1708.

Computer system 1700 may also include a secondary memory 1710. Secondary memory 1710 may include, for example, a hard disk drive 1712, a removable storage drive 1714, a memory stick, etc. A removable storage drive 1714 may comprise a floppy disk drive, a magnetic tape drive, an optical disk drive, a flash memory, or the like. A removable storage drive 1714 reads from and/or writes to a removable storage unit 1716 in a well-known manner. A removable storage unit 1716 may comprise a floppy disk, a magnetic tape, an optical disk, etc. which is read by and written to by removable storage drive 1714. As will be appreciated by persons skilled in the relevant art(s) removable storage unit 1716 includes a computer usable storage medium 1718 having stored therein possibly inter alia computer software and/or data 1720.

In alternative implementations, secondary memory 1710 may include other similar means for allowing computer programs or other instructions to be loaded into computer system 1700. Such means may include, for example, a removable storage unit 1724 and an interface 1722. Examples of such means may include a program cartridge and cartridge interface (such as that found in video game devices), a removable memory chip (such as an Erasable Programmable Read-Only Memory (EPROM), or Programmable Read-Only Memory (PROM)) and associated socket, and other removable storage units 1724 and interfaces 1722 which allow software and data to be transferred from the removable storage unit 1724 to computer system 1700.

Computer system 1700 may also include an input interface 1726 and a range of input devices 1728 such as, possibly inter alia, a keyboard, a mouse, etc.

Computer system 1700 may also include an output interface 1730 and a range of output devices 1732 such as, possibly inter alia, a display, one or more speakers, etc.

Computer system 1700 may also include a communications interface 1734. Communications interface 1734 allows software and/or data 1738 to be transferred between computer system 1700 and external devices. Communications interface 1734 may include a modem, a network interface (such as an Ethernet card), a communications port, a Personal Computer Memory Card International Association (PCMCIA) slot and card, or the like. Software and/or data 1738 transferred via communications interface 1734 are in the form of signals 1736 which may be electronic, electromagnetic, optical, or other signals capable of being received by communications interface 1734. These signals 1736 are provided to communications interface 1734 via a communications path 1740. Communications path 1740 carries signals and may be implemented using a wire or cable, fiber optics, a phone line, a cellular phone link, a Radio Frequency (RF) link or other communication channels.

As used in this document, the terms “computer-program medium,” “computer-usable medium,” and “computer-readable medium” generally refer to media such as removable storage unit 1716, removable storage unit 1724, and a hard disk installed in hard disk drive 1712. Computer program medium and computer usable medium can also refer to memories, such as main memory 1706 and secondary memory 1710, which can be memory semiconductors (e.g. Dynamic Random Access Memory (DRAM) elements, etc.). These computer program products are means for providing software to computer system 1700.

Computer programs (also called computer control logic) are stored in main memory 1706 and/or secondary memory 1710. Such computer programs, when executed, enable computer system 1700 to implement the present technology described herein. In particular, the computer programs, when executed, enable processor 1704 to implement the processes of aspects of the above. Accordingly, such computer programs represent controllers of the computer system 1700. Where the technology described herein is implemented, at least in part, using software, the software may be stored in a computer program product and loaded into computer system 1700 using removable storage drive 1714, interface 1722, hard disk drive 1712 or communications interface 1734.

The technology described herein may be implemented as computer program products comprising software stored on any computer useable medium. Such software, when executed in one or more data processing devices, causes data processing device(s) to operate as described herein. Embodiments of the technology described herein may employ any computer useable or readable medium, known now or in the future. Examples of computer useable mediums include, but are not limited to, primary storage devices (e.g., any type of random access memory), secondary storage devices (e.g., hard drives, floppy disks, Compact Disc Read-Only Memory (CD-ROM) disks, Zip disks, tapes, magnetic storage devices, optical storage devices, Microelectromechanical Systems (MEMS), and nanotechnological storage device, etc.).

A computing system may take the form of any combination of one or more of inter alia a wired device, a wireless device, a mobile phone, a feature phone, a smartphone, a tablet computer (such as for example an iPad™), a mobile computer, a handheld computer, a desktop computer, a laptop computer, a server computer, an in-vehicle (e.g., audio, navigation, etc.) device, an in-appliance device, a Personal Digital Assistant (PDA), a game console, a Digital Video Recorder (DVR) or Personal Video Recorder (PVR), a cable system or other set-top-box, an entertainment system component such as a television set, etc.

In the above description of exemplary implementations, for purposes of explanation, specific numbers, materials configurations, and other details are set forth in order to better explain the present invention, as claimed. However, it will be apparent to one skilled in the art that the claimed invention may be practiced using different details than the exemplary ones described herein. In other instances, well-known features are omitted or simplified to clarify the description of the exemplary implementations.

The inventors intend the described exemplary implementations to be primarily examples. The inventors do not intend these exemplary implementations to limit the scope of the appended claims. Rather, the inventor has contemplated that the claimed invention might also be embodied and implemented in other ways, in conjunction with other present or future technologies.

Moreover, the word “exemplary” is used herein to mean serving as an example, instance, or illustration. Any aspect or design described herein as exemplary is not necessarily to be construed as preferred or advantageous over other aspects or designs. Rather, use of the word “exemplary” is intended to present concepts and techniques in a concrete fashion. The term “technology,” for instance, may refer to one or more devices, apparatuses, systems, methods, articles of manufacture, and/or computer-readable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

Note that the order in which the processes are described is not intended to be construed as a limitation, and any number of the described process blocks can be combined in any order to implement the processes or an alternate process. Additionally, individual blocks may be deleted from the processes without departing from the spirit and scope of the subject matter described herein.

One or more embodiments described herein may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

What is claimed is:

1. A method for organizing functions to scenarios, the method comprising:
determining an initial scenario;
assigning particular functions to the initial scenario;
performing the initial scenario; and
presenting other scenarios that follow the initial scenario.

2. The method according to claim 1, wherein the determining the initial scenario is predefined based on a best estimate.

3. The method according to claim 1, wherein the determining the initial scenario is predefined based on historical user usage.

4. The method according to claim 1, wherein the initial scenario includes a user defined scenario.

5. The method according to claim 1, wherein the assigning includes modification of properties of the particular functions.

6. The method according to claim 1, wherein the presenting is performed with guides that are connected with one another.

7. The method according to claim 1, wherein the presenting includes a user interface with the other scenarios that follow the initial scenario, and an option to finish the initial scenario.

8. The method according to claim 1, wherein the presenting is based on priority values of presented scenarios.

9. The method according to claim 8, wherein the priority values are weighted values.

10. The method according to claim 1 further comprising collecting metrics based on scenarios chosen from the list of presented scenarios.

11. One or more computer-readable media storing processor-executable instructions that when executed cause one or more processors to perform operations that present system scenarios comprising:
presenting an initial scenario with one or more functions;
performing the initial scenario;
determining possible scenarios that follow the initial scenario;
presenting other scenarios; and
determining whether to perform the other scenarios.

12. The one or more computer-readable media according to claim 11, wherein the presenting the initial scenario is predefined based on a best estimate.

13. The one or more computer-readable media according to claim 11, wherein the presenting the initial scenario and presenting the other scenarios are predefined based on historical user usage.

14. The one or more computer-readable media according to claim 11, wherein the one or more functions are assigned by a user to the initial scenario.

15. The one or more computer-readable media according to claim 14, wherein assigning the one or more functions includes modifying properties of the functions.

16. The one or more computer-readable media according to claim 11, wherein the presenting is performed with guides that are connected with one another, and particular to scenarios.

17. The one or more computer-readable media according to claim 11, wherein the presenting the other scenarios includes a user interface with the other scenarios that follow the initial scenario, and an option to finish the initial scenario.

18. The one or more computer-readable media according to claim 11, wherein the presenting the other scenarios is based on priority values of presented scenarios, wherein the priority values have weighted values.

19. A system that facilitates organizing functions to scenarios, the system comprising:
one or more functions;
one or more scenarios that include processes that use the one or more functions;
guides that are associated with the one or more scenarios that present the scenarios; and
user interfaces that are used by the guides to present the scenarios and scenarios that follow based on predetermined or historically determined user usage.

20. The system according to claim 19, wherein the system further collects and records usage of the scenarios.
